(19) United States
(12) Patent Application Publication
(10) Pub. No.: US 2025/0111211 A1
(43) Pub. Date: Apr. 3, 2025

(54) METHODS AND APPARATUS TO PERFORM PROCESS CONTROL ANALYTICS

(71) Applicant: FISHER-ROSEMOUNT SYSTEMS, INC., Round Rock, TX (US)

(72) Inventors: Shaobo Qiu, Cedar Park, TX (US); Gary K. Law, Georgetown, TX (US); Claudio Aun Fayad, Austin, TX (US); Mark Nixon, Thorndale, TX (US)

(21) Appl. No.: 18/902,314

(22) Filed: Sep. 30, 2024

Related U.S. Application Data
(60) Provisional application No. 63/587,428, filed on Oct. 2, 2023.

(51) Int. Cl. G06N 3/0475; G06N 3/096

(52) U.S. Cl. CPC G06N 3/0475; G06N 3/096

(57) ABSTRACT

Systems, apparatus, articles of manufacture, and methods to perform process control analytics are disclosed. An example method includes generating a prompt based on the request for analytics data, providing the prompt to a large language model for generation of analytics instructions, validating the analytics instructions to determine whether the analytics instructions are to be executed, and in response to the determination that the analytics instructions are to be executed, executing the analytics instructions to generate the analytics data.

### RELATED APPLICATION

This patent claims the benefit of U.S. Provisional Patent Application No. 63/587,428, which was filed on Oct. 2, 2023. U.S. Provisional Patent Application No. 63/587,428 is hereby incorporated herein by reference in its entirety. Priority to U.S. Provisional Patent Application No. 63/587,428 is hereby claimed.

### FIELD OF THE DISCLOSURE

This disclosure relates generally to process control systems and, more particularly, to methods and apparatus to perform process control analytics.

### BACKGROUND

Process control systems are used in manufacturing and/or industrial settings to control processes (e.g., manufacturing processes). During such processes, machines are operated to produce an output. Operators of such process control systems desire to know when particular elements in the process control system are operating out of tolerance, malfunctioning, and/or, more generally, operational statistics of the process control system.

### BRIEF DESCRIPTION OF THE DRAWINGS

FIG. 1 is a block diagram of an example environment in which an example process control analytics platform operates to provide analytics information to a user of a process control system.

FIG. 2 is a flowchart representative of example machine readable instructions and/or example operations that may be executed, instantiated, and/or performed by example programmable circuitry to implement the process control analytics platform of FIG. 1 to generate analytics information.

FIGS. 3, 4, 5, 6, and/or 7 are diagrams representing example inputs and corresponding outputs of the process control analytics platform 110 of FIG. 1.

FIG. 8 is a block diagram of an example processing platform including programmable circuitry structured to execute, instantiate, and/or perform the example machine readable instructions and/or perform the example operations of FIG. 2 to implement the process control analytics platform 110 of FIG. 1.

FIG. 9 is a block diagram of an example implementation of the programmable circuitry of FIG. 8.

FIG. 10 is a block diagram of another example implementation of the programmable circuitry of FIG. 8.

FIG. 11 is a block diagram of an example software/firmware/instructions distribution platform (e.g., one or more servers) to distribute software, instructions, and/or firmware (e.g., corresponding to the example machine readable instructions of FIG. 2) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

A process control system is a critical component in industrial and manufacturing settings, designed to manage and regulate various processes and operations. An example purpose of such a process control system is ensuring consistent and efficient production of goods or services while maintaining quality, safety, and optimal resource utilization. Such process control systems utilize a combination of hardware and software to monitor, analyze, and control the variables within a process.

Users, such as operators, administrators, owners, etc. of a process control system seek to understand operational characteristics of the process control system. While in some examples, dashboards, user interfaces, display screens, etc. may be used to present statistics or other such operational characteristics of the process control system, users may desire different visualizations of presented data. Ordinarily, visualizations of such operational characteristics are costly and time-consuming to develop. Creation of such visualizations may require a programmer to understand the requirements of the user, develop code (e.g., instructions) that can be executed to generate the visualizations to meet those requirements, and deploy the code to an environment of the user for operation. Such an approach typically involves a long delay between a user recognizing that a particular visualization is desired, and such a visualization being presented. Moreover, iterating the visualization(s) with a programmer or other consultant may be costly.

Examples disclosed herein utilize artificial intelligence to generate instructions for creation of analytics information (e.g., visualizations, reports, etc.) based on a user request. Artificial intelligence (AI), including machine learning (ML), deep learning (DL), Large Language Models (LLMs) and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

Many different types of machine learning models and/or machine learning architectures exist. In examples disclosed herein, a Large Language Model (LLM) is used. Using an LLM enables customized messages to be generated. In general, machine learning models/architectures that are suitable to use in the example approaches disclosed herein will be transformer-type models, that receive one or more inputs, and generate a corresponding output (e.g., a textual message). However, other types of machine learning models could additionally or alternatively be used.

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.) Alternatively, unsupervised training (e.g., used in deep learning, a subset of machine learning, etc.) involves inferring patterns from inputs to select parameters for the ML/AI model (e.g., without the benefit of expected (e.g., labeled) outputs).

Beyond initial training of a model, further training, sometimes referred to as fine-tuning may be performed. Fine-tuning involves taking an existing, pre-trained model, and further training the model on a smaller, task-specific dataset. An example goal of this process is to make the model adapt to the nuances and requirements of the target task while retaining the valuable knowledge and representations the model has acquired during the initial pre-trained training phase.

In other words, the pre-trained model typically serves as a starting point, providing a foundation of generalized knowledge that spans across various domains. For instance, in natural language processing, pre-trained language models (e.g., GPT-3) have already learned grammar, syntax, and world knowledge from extensive text corpora. Fine-tuning such pre-trained models builds upon this foundation by adjusting the model's weights and parameters based on the new, task-specific data.

To accomplish fine-tuning, a dataset that is specific to the task to be performed is used. This dataset contains examples or samples relevant to the task, often with associated labels or annotations. During fine-tuning, the model is trained to recognize patterns and features in the task-specific data, aligning the internal representations within the model to the requirements of the target task.

Fine-tuning may involve not only updating the model's weights but also adjusting hyperparameters like learning rates, batch sizes, and regularization techniques to ensure that the model converges effectively on the new task. Depending on the complexity of the task, architectural changes may also be made to the model, such as freezing certain layers, adding task-specific layers, or modifying the model structure. Fine-tuning is a powerful technique used in various domains, including natural language processing, computer vision, recommendation systems, and more, as it enables the adaptation of pre-trained models to solve specific real-world problems efficiently and effectively.

Once training is complete, the model is deployed for use as an executable construct that processes an input and provides an output. Such execution of the model is often referred to as an inference phase. In the inference phase, data to be analyzed (e.g., live data) is input to the model, and the model executes to create an output. This inference phase can be thought of as the AI “thinking” to generate the output based on what was learned from the training and/or fine-tuning (e.g., by executing the model to apply the learned patterns and/or associations to the live data). In some examples, input data undergoes pre-processing before being used as an input to the machine learning model. Moreover, in some examples, the output data may undergo post-processing after it is generated by the model to transform the output into a useful result (e.g., a display of data, an instruction to be executed by a machine, etc.).

In some examples, output of the deployed model may be captured and provided as feedback. By analyzing the feedback, an accuracy of the deployed model can be determined. If the feedback indicates that the accuracy of the deployed model is less than a threshold or other criterion, training (e.g., re-training, further fine-tuning, etc.) of an updated model can be triggered using the feedback and/or an updated training data set, hyperparameters, etc., to generate an updated, deployed model.

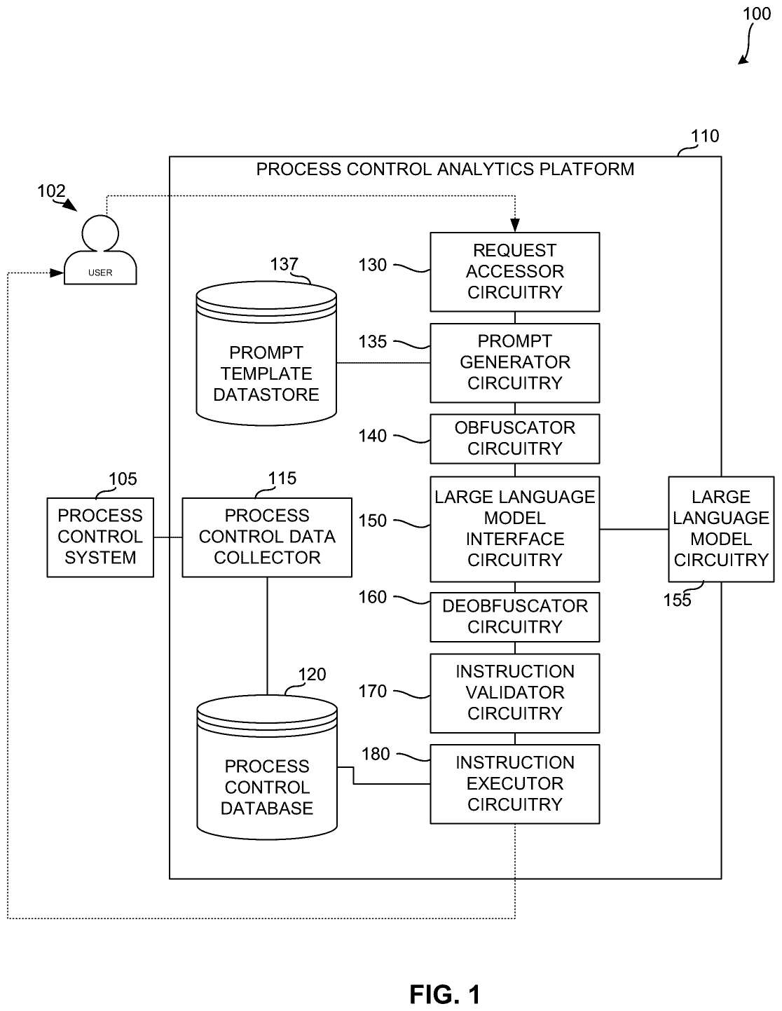

FIG. 1 is a block diagram of an example environment 100 in which an example process control analytics platform 110 operates. In examples disclosed herein, an entity operates the process control analytics platform 110 to monitor operations of a process control system 105.

In examples disclosed herein, the entity operates the process control analytics platform 110. That is, the process control analytics platform 110 may be implemented by one or more servers operating at a facility owned by the entity.

In examples disclosed herein, the users 102 represent operators, owners, administrators, etc. associated with the process control analytics platform 110. However, any other role may be performed by the user. Moreover, the association of a user with the process control analytics platform 110 is not meant to convey a particular relationship between the user and the process control analytics platform 110 and may simply represent a person, process, or other system that is to interact with the process control analytics platform 110.

The example process control system 105 includes a plurality of components that may operate to perform a process. Examples disclosed herein are explained in the context of an industrial and/or manufacturing process, however any other process and/or system may additionally or alternatively be used. Such a process control system may include one or more control modules. Such control modules may implement control loops which may have operational characteristics that are to be monitored by a user. Such operational characteristics may indicate a health of the control loop, variability of production values, variability of inputs and/or outputs, etc. In addition, the process control system may include other devices including, for example, sensors, actuators, electrical components, etc. Such devices may be organized at various logical levels (e.g., device, equipment, unit, etc.). Devices may report, for example, input values, output values, health (e.g., reliability values), etc. Such information may be collected by the process control analytics platform for reporting and/or analysis purposes.

The example process control analytics platform 110 of FIG. 1 may be instantiated (e.g., creating an instance of, bring into being for any length of time, materialize, implement, etc.) by programmable circuitry such as a Central Processor Unit (CPU) executing first instructions. Additionally or alternatively, the process control analytics platform 110 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 1 may, thus, be instantiated at the same or different times. Some or all of the circuitry of FIG. 1 may be instantiated, for example, in one or more threads executing concurrently on hardware and/or in series on hardware. Moreover, in some examples, some or all of the circuitry of FIG. 1 may be implemented by microprocessor circuitry executing instructions and/or FPGA circuitry performing operations to implement one or more virtual machines and/or containers.

In some examples, the process control analytics platform 110 is implemented as an Edge Gateway. In some examples, the process control analytics platform 110 is implemented using an analytics platform such as Jupyter Labs, R, etc.

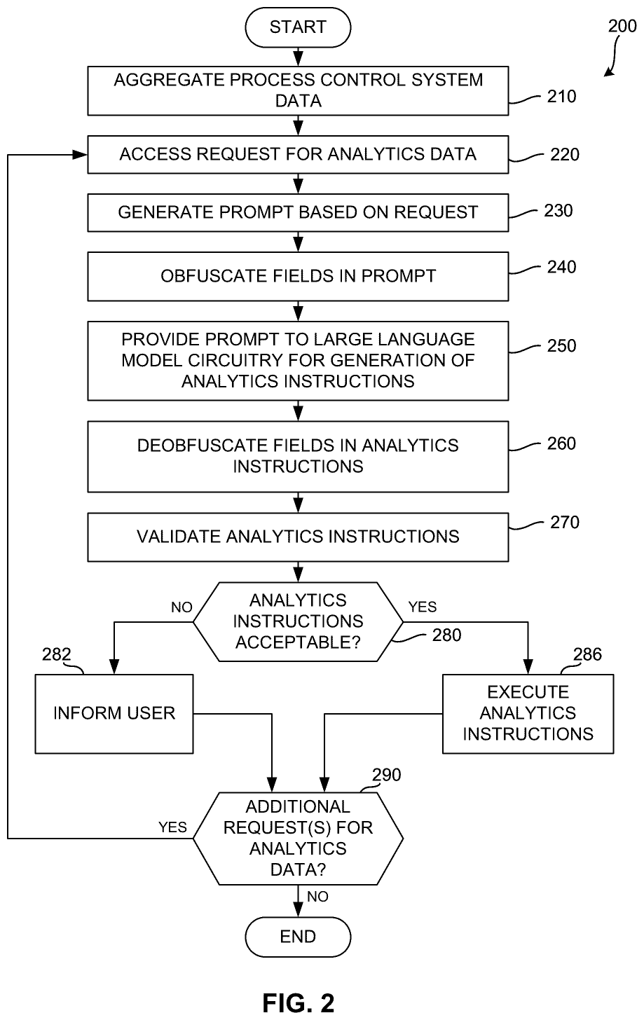

The example process control analytics platform 110 of the illustrated example of FIG. 1 includes a process control data collector 115, a process control database 120, request accessor circuitry 130, prompt generator circuitry 135, a prompt template datastore 137, obfuscator circuitry 140, large language model interface circuitry 150, large language model circuitry 155, deobfuscator circuitry 160, instruction validator circuitry 160, and instruction executor circuitry 170. In some examples, the process control analytics platform 110 is instantiated by programmable circuitry executing analytics instructions and/or configured to perform operations such as those represented by the flowchart(s) of FIG. 2.

The example process control data collector 115 of the illustrated example of FIG. 1 collects information from the process control system 105 and stores such information in the process control database 120. Such information may include, for example, overall health information (e.g., KPIs, quality information, indicators, production values, etc.), health and/or operational statistics for individual entities within the process control system 105 (e.g., control modules, devices, equipment, units, network communicators, etc.)

The example process control database 120 of the illustrated example of FIG. 1 stores process control information collected by the process control data collector 115. In some examples, the process control database 120 and/or the process control data collector 115 are implemented as component(s) of the process control system 105.

The process control database 120 of the illustrated example of FIG. 1 is implemented by any memory, storage device and/or storage disc for storing data such as, for example, flash memory, magnetic media, optical media, solid state memory, hard drive(s), thumb drive(s), etc. Furthermore, the data stored in the example process control database 120 may be in any data format such as, for example, binary data, comma delimited data, tab delimited data, structured query language (SQL) structures, etc. While, in the illustrated example, the process control database 120 is illustrated as a single device, the example process control database 120 and/or any other data storage devices described herein may be implemented by any number and/or type(s) of memories.

The example request accessor circuitry 130 of the illustrated example of FIG. 1 receives a natural language request from the user 102. The request accessor circuitry 130 may be implemented using a web page, command line application, graphical user interface, and/or any other approach for receiving a natural language request from a user.

In some examples, template requests may be provided to the user 102 by the entity operating the process control analytics platform 110. Such templates may provide examples of common analysis to be executed. Example requests received from a user may include, for example:
List all modules with an active bypass alarm.
Show me alarms that have been shelved for longer than [#] [minutes/hours/days]
How many modules are in simulate?
Display all recorded operator actions for [module or area name] for past [#minutes/hours/days]
When was the last Setpoint change to module [module name]? Who made this change? What was the previous Setpoint?
What is the current setpoint (PV/output, etc.) for [module name]
Show Bypass List
Shelved alarms for longer than 2 days
List top 10 alarms in AREA_A for past week
List all loops not in their normal mode.
“List all [*] alarms from [**]”, *—critical, high, low, standing, chattering, **—today, this shift, last shift, last week, last month . . .
“What was [my console*] alarm rate [this shift **]”, *—power station/HCU2/Cracker console . . . , **—last shift/last week/last month . . .
“What safety functions are overridden?”
“List my out of service devices/APC/analyzers . . . ”
What alarms are shelved?
What valves have critical device alerts?
What are my control loops that are different from set point? (high amount of variability)
What interlocks were bypassed in the last shift? (for shift hand-over so they know what's going on) (daily basis query).
Show me the process value for this tag over an x amount of time.
Show me the trend for x amount of time
What interlocks were bypassed in the last shift? (for shift hand-over so they know what's going on) (daily basis query)
Show me interlocks on unit, area, equipment.
What is the temperature for T208
What processes are operating today
What is the distillation steam pressure (we could look at key parameters for equipment, compare equipment, etc.)
What is the distillation packing pressure drop
What is the ambient temperature?
Is my measurement OK?
Sensor health (measurement and final control elements)
Are sensors drifting?

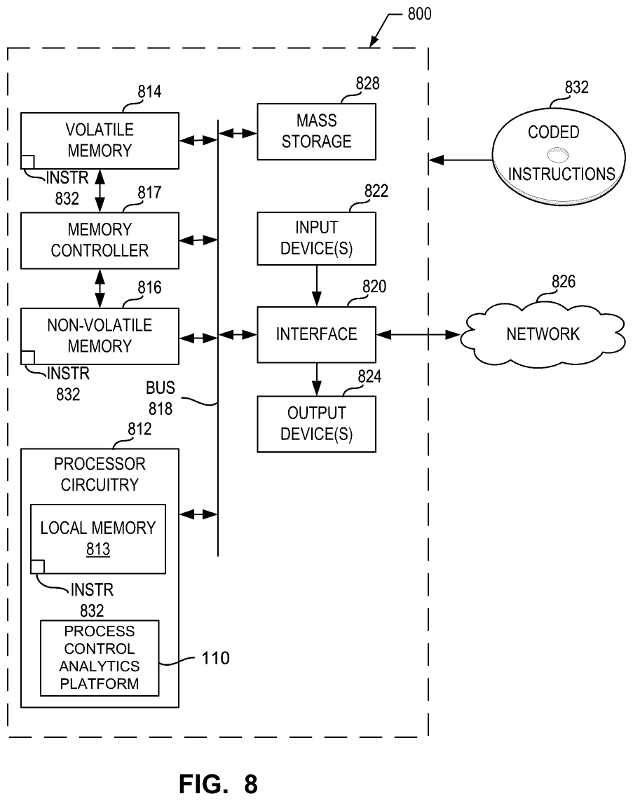

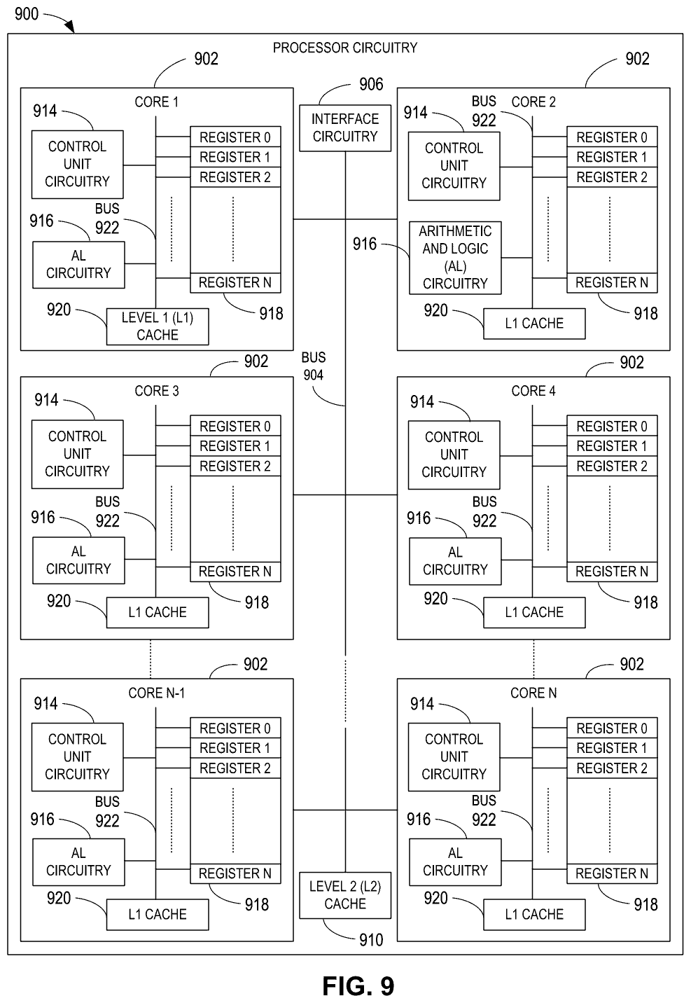

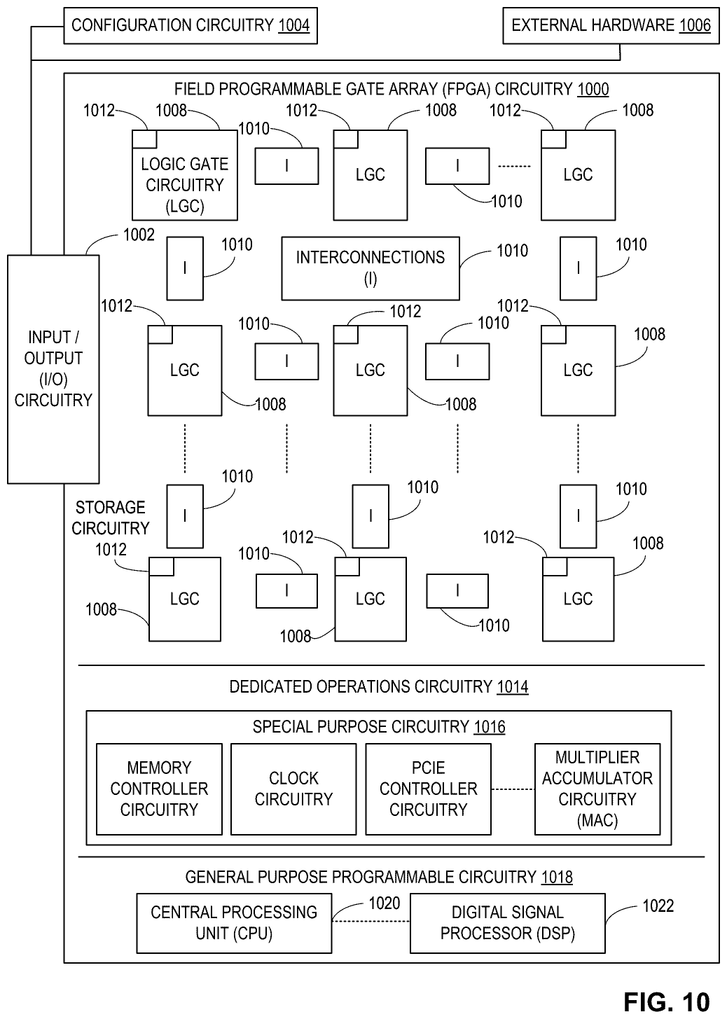

In some examples, the process control analytics platform 110 includes means for accessing. For example, the means for accessing may be implemented by request accessor circuitry 130. In some examples, the request accessor circuitry 130 may be instantiated by programmable circuitry such as the example programmable circuitry 812 of FIG. 8. For instance, the request accessor circuitry 130 may be instantiated by the example microprocessor 900 of FIG. 9 executing machine executable instructions such as those implemented by at least block 220 of FIG. 2. In some examples, the request accessor circuitry 130 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the request accessor circuitry 130 may be instantiated by any other combination of hardware, software, and/or firmware. For example, the request accessor circuitry 130 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example prompt generator circuitry 135 of the illustrated example of FIG. 1 generates a prompt based on the request from the user 102. In some examples, the prompt generator circuitry 135 utilizes a prompt template (stored in the prompt template datastore 137) to generate the prompt. Example prompts may include, for example, a general instruction to define a context of operation for the large language model circuitry 155, and a more specific instruction based on the request accessed by the request accessor circuitry 130. In some examples, the prompt includes an explanation of a desired output format (e.g., “please provide python instructions using the pandas and matplot libraries”). In this manner, the LLM circuitry 155 will return instructions that may be executed within the environment of the process control analytics platform 110 to generate the requested analytics information. As such, the returned instructions may be written in a language that is usable within a Jupyter platform.

In some examples, the process control analytics platform 110 includes means for generating. For example, the means for generating may be implemented by prompt generator circuitry 135. In some examples, the prompt generator circuitry 135 may be instantiated by programmable circuitry such as the example programmable circuitry 812 of FIG. 8. For instance, the prompt generator circuitry 135 may be instantiated by the example microprocessor 900 of FIG. 9 executing machine executable instructions such as those implemented by at least block 230 of FIG. 2. In some examples, the prompt generator circuitry 135 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the prompt generator circuitry 135 may be instantiated by any other combination of hardware, software, and/or firmware. For example, the prompt generator circuitry 135 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example prompt template datastore 145 of the illustrated example of FIG. 1 stores one or more prompt templates that are used by the prompt generator circuitry 135 for generation of a prompt. The example prompt template datastore 137 of the illustrated example of FIG. 1 is implemented by any memory, storage device and/or storage disc for storing data such as, for example, flash memory, magnetic media, optical media, solid state memory, hard drive(s), thumb drive(s), etc. Furthermore, the data stored in the example prompt template datastore 137 may be in any data format such as, for example, binary data, comma delimited data, tab delimited data, structured query language (SQL) structures, etc. While, in the illustrated example, the prompt template datastore 137 is illustrated as a single device, the example prompt template datastore 137 and/or any other data storage devices described herein may be implemented by any number and/or type(s) of memories.

The example obfuscator circuitry 140 of the illustrated example of FIG. 1 reviews the prompt created by the prompt generator circuitry 135, and obfuscates information from the prompt. Obfuscating information ensures that variables and/or internal structures of the process control system are not disseminated to third parties. For example, if the LLM circuitry 155 were hosted by a third party, an entity operating the process control analytics platform might not necessarily desire to have internal structures of their process control system provided to the third party. To perform such obfuscation, the obfuscation circuitry 140 may utilize a list of translations to translate words, terms, and/or phrases in the generated prompt into a sanitized version of the word, term, and/or phrase. For example, a name of the process control system may be replaced with the term [PlatformName], and a name of a company (e.g., the entity operating the process control system) may be replaced with [Your Company's Name]. In some examples, when using PANDAS, any data that is to be transmitted as part of the request to the LLM is transformed into a DataFrame, such that the headers may be obfuscated.

In some examples, the process control analytics platform 110 includes means for obfuscating. For example, the means for obfuscating may be implemented by obfuscator circuitry 140. In some examples, the obfuscator circuitry 140 may be instantiated by programmable circuitry such as the example programmable circuitry 812 of FIG. 8. For instance, the obfuscator circuitry 140 may be instantiated by the example microprocessor 900 of FIG. 9 executing machine executable instructions such as those implemented by at least block 240 of FIG. 2. In some examples, the obfuscator circuitry 140 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the obfuscator circuitry 140 may be instantiated by any other combination of hardware, software, and/or firmware. For example, the obfuscator circuitry 140 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example large language model interface circuitry 150 of the illustrated example of FIG. 1 receives the prompt generated by the prompt generator circuitry 140 and provides the prompt to the large language model circuitry 155. The example large language model interface circuitry 150 receives a response from the large language model circuitry 155 including the proposed instructions.

The example large language model interface circuitry 150 may interface with the LLM circuitry 155 differently depending on how the LLM circuitry 155 is implemented. For example, if the LLM circuitry 155 is implemented locally to the process control analytics platform 110 (e.g., on a same computer), the large language model interface circuitry 150 may utilize a dynamically linked library (DLL) or other application programming interface (API) to cause execution of the LLM circuitry 155. Alternatively, if the LLM circuitry 155 is implemented remotely from the large language model interface circuitry 150 (e.g., on a different computer), the large language model interface circuitry 150 may communicate with the LLM circuitry 155 using network communications (e.g., via a representational state transfer (REST) API). In some examples, the LLM circuitry 155 may be implemented at a different host (e.g., a physical host, a virtual host, etc.) within the process control analytics platform 110 than the large language model interface circuitry 150.

In some examples, the process control analytics platform 110 includes means for interfacing. For example, the means for interfacing may be implemented by large language model interface circuitry 150. In some examples, the large language model interface circuitry 150 may be instantiated by programmable circuitry such as the example programmable circuitry 812 of FIG. 8. For instance, the large language model interface circuitry 150 may be instantiated by the example microprocessor 900 of FIG. 9 executing machine executable instructions such as those implemented by at least block 250 of FIG. 2. In some examples, the large language model interface circuitry 150 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the large language model interface circuitry 150 may be instantiated by any other combination of hardware, software, and/or firmware. For example, the large language model interface circuitry 150 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example large language model circuitry 155 of the illustrated example of FIG. 1 executes a large language model to transform an input prompt into an output message. A large language model (LLM) operates by utilizing a neural network architecture known as a Transformer. LLMs are designed to understand and generate human-like text based on the vast amount of data on which the LLM has been trained.

In the illustrated example of FIG. 1, the LLM circuitry 155 is illustrated at the edge of the process control analytics platform 110 to represent that the large language model circuitry 155 may be executed/implemented either locally to the process control analytics platform 110 or at a computing system remote from the process control analytics platform 110. For example, large language models may be executed in a cloud setting (e.g., remotely from the process control analytics platform 110). Remote execution offers some advantages including, for example, that the LLM can be accessed from anywhere, providing scalability and ease of use. Cloud-based models are usually more powerful than locally-executed models, as cloud-based models typically leverage high-performance hardware and are continuously updated with the latest improvements and fine-tuning. However, cloud-based models may raise concerns about data privacy, latency, and cost, as entities typically pay for the computational resources they consume (e.g., entities pay for use of the cloud-based model).

On the other hand, executing large language models locally provides an entity with more control over their data, and potentially lower latency for inference. Local execution can also work offline, which is beneficial in scenarios with limited Internet access or where data privacy is important. However, local execution typically requires powerful hardware, significant storage, and regular updates to maintain model performance.

In some examples, the process control analytics platform 110 includes means for inferring. For example, the means for inferring may be implemented by LLM circuitry 155. In some examples, the LLM circuitry 155 may be instantiated by programmable circuitry such as the example programmable circuitry 812 of FIG. 8. In some examples, LLM circuitry 155 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the LLM circuitry 155 may be instantiated by any other combination of hardware, software, and/or firmware. For example, the LLM circuitry 155 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example deobfuscator circuitry 160 of the illustrated example of FIG. 1 de-obfuscates words, terms, and/or phrases that were obfuscated by the obfuscator circuitry 140 within the proposed instructions. In this manner, the proposed instructions are updated to produce information that is meaningful to the user. For example, the term [PlatformName] may be replaced with a user-understandable name of a process control system 105, and [Your Company's Name] may be replaced with a name of a company. In some examples, the deobfuscation of the returned instructions de-abstracts values from headers of a data frame that may have been provided to the LLM, to enable execution of the deobfuscated instructions.

In some examples, the process control analytics platform 110 includes means for deobfuscating. For example, the means for deobfuscating may be implemented by deobfuscator circuitry 160. In some examples, the deobfuscator circuitry 160 may be instantiated by programmable circuitry such as the example programmable circuitry 812 of FIG. 8. For instance, the deobfuscator circuitry 160 may be instantiated by the example microprocessor 900 of FIG. 9 executing machine executable instructions such as those implemented by at least block 260 of FIG. 2. In some examples, the deobfuscator circuitry 160 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the deobfuscator circuitry 160 may be instantiated by any other combination of hardware, software, and/or firmware. For example, the deobfuscator circuitry 160 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example instruction validator circuitry 170 of the illustrated example of FIG. 1 reviews the de-obfuscated instructions provided by the deobfuscator circuitry 160 to determine if the instructions is/are acceptable for execution. In some examples, the instructions are reviewed to ensure that they comply with various policies that may have been put in place by the entity operating the process control system 105 and/or the process control analytics platform 110. In some examples, the instruction validator circuitry 170 may utilize the large language model interface circuitry 150 and an additional prompt to cause the LLM circuitry 155 to perform the validation. In some examples, the instructions are validated to determine that they do not perform any unintended activities (e.g., delete data, send a message to a third party, insert additional data, etc.). If the instructions are acceptable, the instructions are executed to provide the requested analytics information (e.g., visualization) to the user 102. If the instructions are not acceptable, the user may be informed that the analytics could not be generated.

In some examples, the process control analytics platform 110 includes means for validating. For example, the means for validating may be implemented by validator circuitry 170. In some examples, the validator circuitry 170 may be instantiated by programmable circuitry such as the example programmable circuitry 812 of FIG. 8. For instance, the validator circuitry 170 may be instantiated by the example microprocessor 900 of FIG. 9 executing machine executable instructions such as those implemented by at least block 270 of FIG. 2. In some examples, the validator circuitry 170 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the validator circuitry 170 may be instantiated by any other combination of hardware, software, and/or firmware. For example, the validator circuitry 170 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example instruction executor circuitry 180 of the illustrated example of FIG. 1 executes the deobfuscated instructions. In examples disclosed herein, the deobfuscated instructions are executed locally (e.g., within the process control analytics platform 110), and access data stored in the process control database 120 to generate one or more visualizations. In this manner, results of the execution of the deobfuscated instructions may be plotted, tabulated, graphed, etc. as appropriate.

In some examples, the process control analytics platform 110 includes means for executing. For example, the means for executing may be implemented by instruction executor circuitry 180. In some examples, the instruction executor circuitry 180 may be instantiated by programmable circuitry such as the example programmable circuitry 812 of FIG. 8. For instance, the instruction executor circuitry 180 may be instantiated by the example microprocessor 900 of FIG. 9 executing machine executable instructions such as those implemented by at least block 286 of FIG. 2. In some examples, the instruction executor circuitry 180 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the instruction executor circuitry 180 may be instantiated by any other combination of hardware, software, and/or firmware. For example, the instruction executor circuitry 180 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the process control analytics platform 110 of FIG. 1 is illustrated in FIG. 1, one or more of the elements, processes, and/or devices illustrated in FIG. 1 may be combined, divided, re-arranged, omitted, eliminated, and/or implemented in any other way. Further, the example process control data collector 115, the example request accessor circuitry 130, the example prompt generator circuitry 135, the example obfuscator circuitry 140, the example large language model interface circuitry 150, the example LLM circuitry 155, the example deobfuscator circuitry 160, the example instruction validator circuitry 170, the example instruction executor circuitry 180, and/or, more generally, the example process control analytics platform 110 of FIG. 1, may be implemented by hardware alone or by hardware in combination with software and/or firmware. Thus, for example, any of the example process control data collector 115, the example request accessor circuitry 130, the example prompt generator circuitry 135, the example obfuscator circuitry 140, the example large language model interface circuitry 150, the example LLM circuitry 155, the example deobfuscator circuitry 160, the example instruction validator circuitry 170, the example instruction executor circuitry 180, and/or, more generally, the example process control analytics platform 110, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example process control analytics platform 110 of FIG. 1 may include one or more elements, processes, and/or devices in addition to, or instead of, those illustrated in FIG. 1, and/or may include more than one of any or all of the illustrated elements, processes and devices.

Flowchart(s) representative of example machine readable instructions, which may be executed by programmable circuitry to implement and/or instantiate the process control analytics platform 110 of FIG. 1 and/or representative of example operations which may be performed by programmable circuitry to implement and/or instantiate the process control analytics platform 110 of FIG. 1, are shown in FIG. 2. The machine readable instructions may be one or more executable programs or portion(s) of one or more executable programs for execution by programmable circuitry such as the programmable circuitry 812 shown in the example processor platform 800 discussed below in connection with FIG. 8 and/or may be one or more function(s) or portion(s) of functions to be performed by the example programmable circuitry (e.g., an FPGA) discussed below in connection with FIGS. 9 and/or 10. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIG. 2, many other methods of implementing the example process control analytics platform 110 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIG. 2 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 2 is a flowchart representative of example machine readable instructions and/or example operations 200 that may be executed, instantiated, and/or performed by programmable circuitry to generate analytics information. The example machine-readable instructions and/or the example operations 200 of FIG. 2 begin at block 210, at which the process control data collector 115 aggregates process control system data in the process control database 120. (Block 210). The example request accessor circuitry 130 accesses a request for analytics data from the user 102. (Block 220). The example request for analytics data may be received in any fashion including, for example, a web-based user interface, a command line interface, a voice-based assistant, etc.

The example prompt generator 135 generates a prompt based on the user request. (Block 230). In some examples, a template stored in the prompt template datastore 137 may be used to generate the prompt in addition to the user request. For example, the template may be used to provide standardized instructions to the LLM circuitry 155 including, for example, instructions related to the operational environment in which the generated response will be executed. For example, if the user requested generation of analytics instructions for creation of a dashboard showing a status of a process within a process control system, the template might include information related to the packages, libraries, programming languages, operating systems, etc. available for use within the process control system. Such an approach results in the generation of instructions for creation of the requested dashboard that are more likely to be executable without error. Of course, other standardized instructions might be included in the template as well.

The example obfuscator circuitry 140 obfuscates the generated prompt. (Block 240). In some examples, this obfuscation may be performed to ensure confidentiality. Obfuscating information ensures that variables and/or internal structures of the process control system are not disseminated to third parties. For example, if the LLM circuitry 155 were hosted by a third party, an entity operating the process control analytics platform might not necessarily desire to have internal structures of their process control system provided to the third party. To perform such obfuscation, the obfuscation circuitry 140 may utilize a list of translations to translate words, terms, and/or phrases in the generated prompt into a sanitized version of the word, term, and/or phrase. For example, a name of the process control system may be replaced with the term [PlatformName], and a name of a company (e.g., the entity operating the process control system) may be replaced with [Your Company's Name]. In some examples, when using PANDAS, any data that is to be transmitted as part of the request to the LLM is transformed into a DataFrame, such that the headers may be obfuscated. In some examples, other terms within the prompt may also be obfuscated, such as variable names. The obfuscation of variable names may reduce the likelihood that verbose variable names might degrade the quality of result of the execution of the prompt. In some examples, the obfuscation circuitry 140 stores a list of obfuscated terms that is later used for de-obfuscation.

The example large language model interface circuitry 150 provides the obfuscated prompt to the LLM circuitry 155 for generation of analytics instructions. (Block 250). In examples disclosed herein, the prompt template instructs the LLM circuitry 155 to provide analytics instructions to comply with the user request. In response to the prompt, the LLM circuitry 155 provides the generated analytics instructions to the

The example deobfuscator circuitry 160 deobfuscates the received analytics instructions. (Block 260). The instruction validator circuitry 180 validates the deobfuscated instructions to confirm that they are safe to be executed. (Block 270). In some examples, the instructions are validated to determine that they do not perform any unintended activities (e.g., delete data, send a message to a third party, insert additional data, etc.). In some examples, the instructions are reviewed to ensure that the de-obfuscated instructions comply with various policies that may have been put in place by the entity operating the process control system 105 and/or the process control analytics platform 110. Other types of validation may additionally or alternatively be performed including, for example, syntax validation, semantic validation, performance validation, security validation, compliance validation, etc.

Syntax validation, for example, might be used to confirm that the de-obfuscated instructions conform to the syntax and/or structure expected by the instruction executor circuitry 180. Semantic validation, for example, might be used to confirm that the de-obfuscated instructions are semantically correct and/or make sense within the context of the process control system 105 and/or the process control analytics platform 110. Performance validation might be used to confirm that the de-obfuscated instructions are likely to be efficient and/or effective in terms of performance and/or resource utilization. Such performance validation might be used to ensure that long-running analytics tasks are not unintentionally started without user and/or administrator involvement/approval. Security validation might be used to ensure that the de-obfuscated instructions are secure and do not pose a risk to the process control system 105, the process control analytics platform 110, and/or other sensitive data or resources. Security validation ensures that the de-obfuscated analytics instructions do not contain malicious code or exploits, and may also ensure that the de-obfuscated analytics instructions do not compromise the confidentiality, integrity, or availability of data within the process control system. Compliance validation might be utilized to confirm that the de-obfuscated instructions comply with relevant regulations, standards, and/or best practices related to process control, analytics, and data privacy.

In some examples, the instruction validator circuitry 170 may utilize the large language model interface circuitry 150 and an additional prompt to cause the LLM circuitry 155 to perform the validation. For example, one or more prompts may be provided to the LLM circuitry 155 requesting validation. Separate prompts might be used to request different types of validation, or such different types of validation might be grouped into fewer or a single prompt.

In some examples, if unintended activities are detected, an administrator of the process control analytics platform 110 may be notified (e.g., in addition to the notification of the user 102 described below at block 282). In such an example, the administrator might use the notification and/or a pattern of notifications to modify the prompt template. For example, if a message was to be sent to a third party when executing the analytics instructions, the prompt template might be updated to forbid analytics instructions that transmit messages to third parties.

If the analytics instructions are not acceptable (block 280 returns a result of NO), the instruction executor circuitry 180 informs the user 102 that the analytics instructions could not be executed. (Block 282). In some examples, the determination of whether the deobfuscated analytics instructions can be executed is made by attempting to execute the deobfuscated analytics instructions (e.g., within a test and/or sandbox environment) and determining if an error message is received. The determination of whether an issue is detected by the instruction validator circuitry (e.g., unintended activities are detected, compilation fails, test execution fails, etc.), the user 102 or an administrator of the process control analytics platform 110 may be notified, enabling the user or administrator to manually validate the instructions. The user 102 may then provide a manual override to enable execution of the analytics instructions, or may take other action such as re-formulating their initial request.

In some examples, an administrator may be informed that the instructions could not be executed and, furthermore, might be provided with an explanation of why the instructions could not be executed (e.g., a policy violation, a possible data breach, instructions that cannot be executed, etc.).

If the analytics instructions are acceptable (block 280 returns a result of YES), the example instruction executor circuitry 180 executes the analytics instructions and provides a result of the execution to the user 102. (Block 286). The result of the execution may include, for example, a visualization of the requested information (e.g., a pie chart, a bar graph, a chart, a table of data, a natural language response, etc.). In this manner, the instructions are executed locally within the context of the process control analytics platform 110 and/or the process control system 105. As such, information about the process control system 105 and/or the process control analytics platform 110 is not shared with third parties. In some examples, the instructions are saved for later (e.g., subsequent execution). In this manner, analytics information from one time period can be re-executed to present analytics information for a second (e.g., later) time period.

The example request accessor circuitry 130 determines whether there are additional request(s) for analytics data. (Block 290). If additional requests are present, control returns to block 220, where the additional requests are processed. If no additional requests are present, the example process 200 of FIG. 2 ends. The example process of FIG. 2 may be repeated upon, for example, subsequent receipt of a user request, receipt of an indication of updated process control system data, etc.

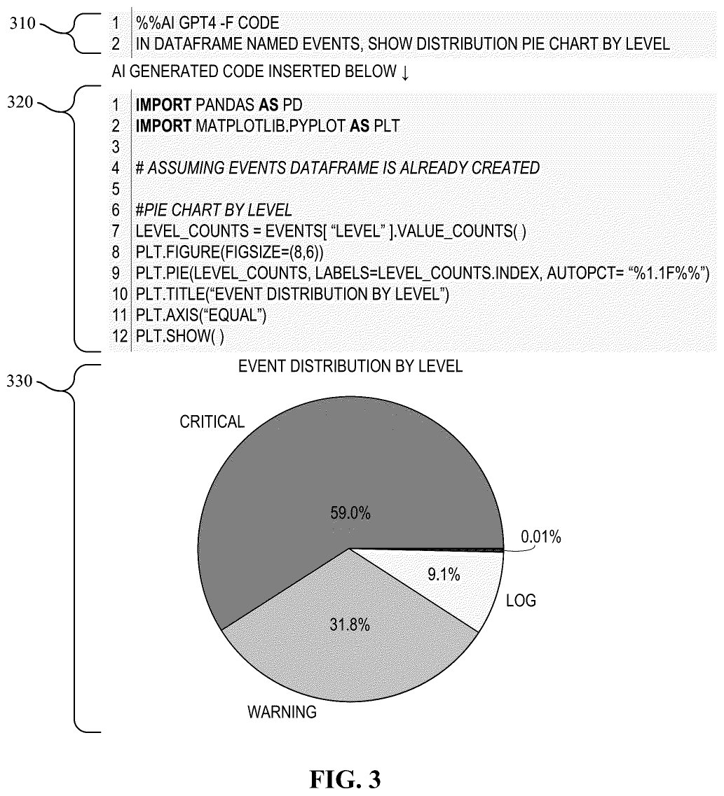

FIG. 3 represents an example situation in which a user request 310 is processed to generate instructions 320 that are executed to provide a visualization 330. In the illustrated example of FIG. 3, the user request 310 indicates that a pie chart is to be created showing a distribution of events by level. The resultant analytics instructions 320 are executed by the instruction executor circuitry 180 to generate the visualization 330 (e.g., the requested pie chart).

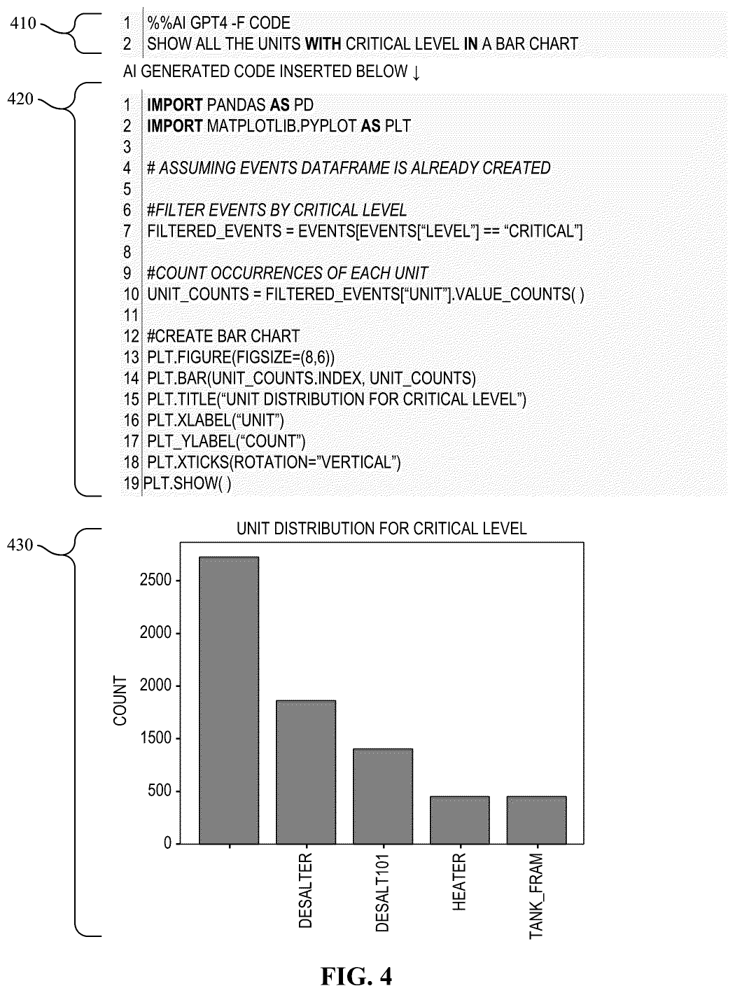

FIG. 4 represents an example situation in which a user request 410 is processed to generate instructions 420 that are executed to provide a visualization 430. In the illustrated example of FIG. 4, the user request 410 indicates that a bar chart is to be created showing units with a critical level. The resultant analytics instructions 420 are executed by the instruction executor circuitry 180 to generate the visualization 430 (e.g., the requested bar chart).

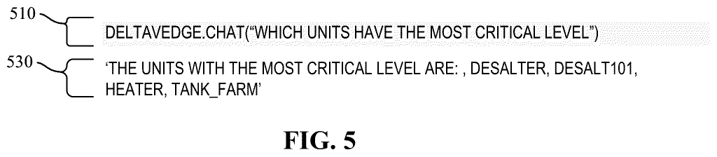

FIG. 5 represents an example situation in which a user request 510 is processed to generate instructions that are executed to provide analytics information 530. In the illustrated example of FIG. 5, the user request 510 asks which units have the most critical level. The resultant analytics instructions are executed by the instruction executor circuitry 180 to generate a natural language response indicating which units have the most critical level (e.g., the requested analytics information).

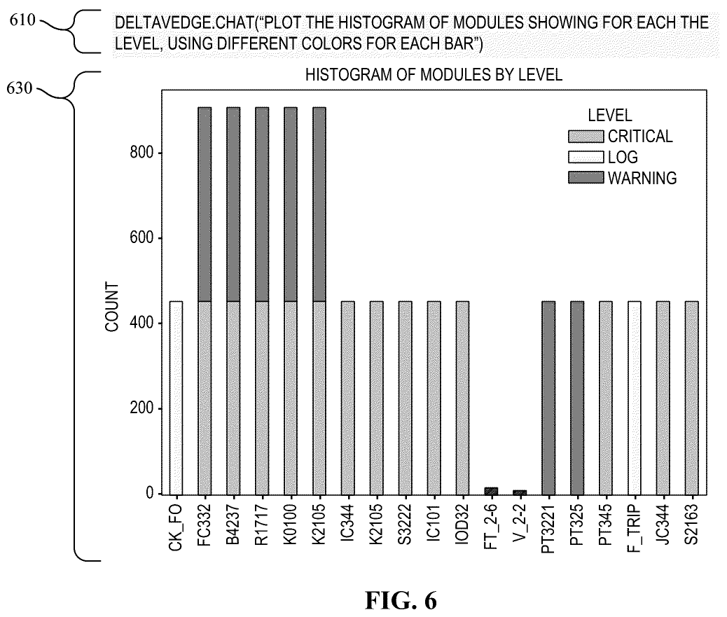

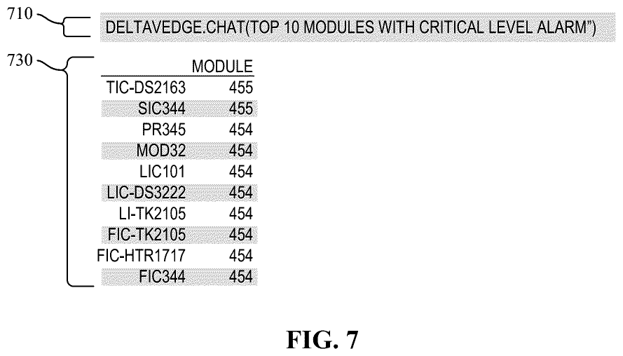

FIG. 6 represents an example situation in which a user request 610 is processed to generate instructions that are executed to provide a visualization 630. In the illustrated example of FIG. 6, the user request 610 indicates that a histogram of modules is to be created. The resultant analytics instructions are executed by the instruction executor circuitry 180 to generate the visualization 630 (e.g., the requested histogram).

FIG. 7 represents an example situation in which a user request 710 is processed to generate instructions that are executed to provide analytics information about modules having critical alarms. In the illustrated example of FIG. 3, the user request 310 indicates that the top ten modules having critical alarm levels are to be identified. The resultant analytics instructions are executed by the instruction executor circuitry 180 to generate the results 730 in a tabular format (e.g., the requested identification of modules).

In the illustrated examples of FIGS. 3 and 4, the request is received using a command line format (e.g., executing the instruction “ai” with switches “gpt4” and “-f code”, and with a user request value represented in line 2. In contrast, in the illustrated examples of FIGS. 5, 6, and 7, an application programming interface styled request is utilized, where a function call is utilized to provide the request accessor circuitry 130 with the request. While such examples are illustrated herein, additional or alternative examples may additionally or alternatively be utilized such as, for example, a web interface.

FIG. 8 is a block diagram of an example programmable circuitry platform 800 structured to execute and/or instantiate the example machine-readable instructions and/or the example operations of FIG. 2 to implement the process control analytics platform 110 of FIG. 1. The programmable circuitry platform 800 can be, for example, a server, a personal computer, a workstation, a self-learning machine (e.g., a neural network), a mobile device (e.g., a cell phone, a smart phone, a tablet such as an iPad™M), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs, microprocessors, CPUs, GPUs, DSPs, and/or microcontrollers from any desired family or manufacturer. The programmable circuitry 812 may be implemented by one or more semiconductor based (e.g., silicon based) devices. In this example, the programmable circuitry 812 implements the example process control analytics platform 110.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816.

The programmable circuitry platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter data and/or commands into the programmable circuitry 812. The input device(s) 822 can be implemented by, for example, an audio sensor, a microphone, a camera (still or video), a keyboard, a button, a mouse, a touchscreen, a trackpad, a trackball, an isopoint device, and/or a voice recognition system.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 800 of the illustrated example also includes one or more mass storage discs or devices 828 to store firmware, software, and/or data. Examples of such mass storage discs or devices 828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 832, which may be implemented by the machine readable instructions of FIG. 2, may be stored in the mass storage device 828, in the volatile memory 814, in the non-volatile memory 816, and/or on at least one non-transitory computer readable storage medium such as a CD or DVD which may be removable.

FIG. 9 is a block diagram of an example implementation of the programmable circuitry 812 of FIG. 8. In this example, the programmable circuitry 812 of FIG. 8 is implemented by a microprocessor 900. For example, the microprocessor 900 may be a general-purpose microprocessor (e.g., general-purpose microprocessor circuitry). The microprocessor 900 executes some or all of the machine-readable instructions of the flowchart of FIG. 2 to effectively instantiate the circuitry of FIG. 2 as logic circuits to perform operations corresponding to those machine readable instructions. In some such examples, the circuitry of FIG. 1 is instantiated by the hardware circuits of the microprocessor 900 in combination with the machine-readable instructions. For example, the microprocessor 900 may be implemented by multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine readable instructions and/or operations represented by the flowchart of FIG. 2.

The cores 902 may communicate by a first example bus 904. In some examples, the first bus 904 may be implemented by a communication bus to effectuate communication associated with one(s) of the cores 902. For example, the first bus 904 may be implemented by at least one of an Inter-Integrated Circuit (I2C) bus, a Serial Peripheral Interface (SPI) bus, a PCI bus, or a PCIe bus. Additionally or alternatively, the first bus 904 may be implemented by any other type of computing or electrical bus. The cores 902 may obtain data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2 cache)) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry (sometimes referred to as an ALU) 916, a plurality of registers 918, the local memory 920, and a second example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer based operations. In other examples, the AL circuitry 916 also performs floating-point operations. In yet other examples, the AL circuitry 916 may include first AL circuitry that performs integer-based operations and second AL circuitry that performs floating-point operations. In some examples, the AL circuitry 916 may be referred to as an Arithmetic Logic Unit (ALU).

The registers 918 are semiconductor-based structures to store data and/or instructions such as results of one or more of the operations performed by the AL circuitry 916 of the corresponding core 902. For example, the registers 918 may include vector register(s), SIMD register(s), general-purpose register(s), flag register(s), segment register(s), machine-specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure, such as by being distributed throughout the core 902 to shorten access time. The second bus 922 may be implemented by at least one of an I2C bus, a SPI bus, a PCI bus, or a PCIe bus.

Each core 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (ICs) contained in one or more packages.

The microprocessor 900 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 900, in the same chip package as the microprocessor 900 and/or in one or more separate packages from the microprocessor 900.

FIG. 10 is a block diagram of another example implementation of the programmable circuitry 812 of FIG. 8. In this example, the programmable circuitry 812 is implemented by FPGA circuitry 1000. For example, the FPGA circuitry 1000 may be implemented by an FPGA. The FPGA circuitry 1000 can be used, for example, to perform operations that could otherwise be performed by the example microprocessor 900 of FIG. 9 executing corresponding machine readable instructions. However, once configured, the FPGA circuitry 1000 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 900 of FIG. 9 described above (which is a general purpose device that may be programmed to execute some or all of the machine readable instructions represented by the flowchart(s) of FIG. 2 but whose interconnections and logic circuitry are fixed once fabricated), the FPGA circuitry 1000 of the example of FIG. 10 includes interconnections and logic circuitry that may be configured, structured, programmed, and/or interconnected in different ways after fabrication to instantiate, for example, some or all of the operations/functions corresponding to the machine readable instructions represented by the flowchart(s) of FIG. 2. In particular, the FPGA circuitry 1000 may be thought of as an array of logic gates, interconnections, and switches. The switches can be programmed to change how the logic gates are interconnected by the interconnections, effectively forming one or more dedicated logic circuits (unless and until the FPGA circuitry 1000 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIG. 2. As such, the FPGA circuitry 1000 may be configured and/or structured to effectively instantiate some or all of the operations/functions corresponding to the machine readable instructions of the flowchart(s) of FIG. 2 as dedicated logic circuits to perform the operations/functions corresponding to those software instructions in a dedicated manner analogous to an ASIC. Therefore, the FPGA circuitry 1000 may perform the operations/functions corresponding to the some or all of the machine readable instructions of FIG. 2 faster than the general-purpose microprocessor can execute the same.

In the example of FIG. 10, the FPGA circuitry 1000 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

The FPGA circuitry 1000 of FIG. 10, includes example input/output (I/O) circuitry 1002 to obtain and/or output data to/from example configuration circuitry 1004 and/or external hardware 1006. For example, the configuration circuitry 1004 may be implemented by interface circuitry that may obtain a binary file, which may be implemented by a bit stream, data, and/or machine-readable instructions, to configure the FPGA circuitry 1000, or portion(s) thereof. In some such examples, the configuration circuitry 1004 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1006 may be implemented by external hardware circuitry. For example, the external hardware 1006 may be implemented by the microprocessor 900 of FIG. 9.

The FPGA circuitry 1000 also includes an array of example logic gate circuitry 1008, a plurality of example configurable interconnections 1010, and example storage circuitry 1012. The logic gate circuitry 1008 and the configurable interconnections 1010 are configurable to instantiate one or more operations/functions that may correspond to at least some of the machine readable instructions of FIG. 2 and/or other desired operations. The logic gate circuitry 1008 shown in FIG. 10 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of the electrical structures and/or the logic gates to form circuits to perform desired operations/functions. The logic gate circuitry 1008 may include other electrical structures such as look-up tables (LUTs), registers (e.g., flip-flops or latches), multiplexers, etc.

The configurable interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example dedicated operations circuitry 1014. In this example, the dedicated operations circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as an example CPU 1020 and/or an example DSP 1022. Other general purpose programmable circuitry 1018 may additionally or alternatively be present such as a GPU, an XPU, etc., that can be programmed to perform other operations.

Although FIGS. 9 and 10 illustrate two example implementations of the programmable circuitry 812 of FIG. 8, many other approaches are contemplated. For example, FPGA circuitry may include an on-board CPU, such as one or more of the example CPU 1020 of FIG. 9. Therefore, the programmable circuitry 812 of FIG. 8 may additionally be implemented by combining at least the example microprocessor 900 of FIG. 9 and the example FPGA circuitry 1000 of FIG. 10. In some such hybrid examples, one or more cores 902 of FIG. 9 may execute a first portion of the machine readable instructions represented by the flowchart(s) of FIG. 2 to perform first operation(s)/function(s), the FPGA circuitry 1000 of FIG. 10 may be configured and/or structured to perform second operation(s)/function(s) corresponding to a second portion of the machine readable instructions represented by the flowchart of FIG. 2, and/or an ASIC may be configured and/or structured to perform third operation(s)/function(s) corresponding to a third portion of the machine readable instructions represented by the flowchart of FIG. 2.

It should be understood that some or all of the circuitry of FIG. 1 may, thus, be instantiated at the same or different times. For example, same and/or different portion(s) of the microprocessor 900 of FIG. 9 may be programmed to execute portion(s) of machine-readable instructions at the same and/or different times. In some examples, same and/or different portion(s) of the FPGA circuitry 1000 of FIG. 10 may be configured and/or structured to perform operations/functions corresponding to portion(s) of machine-readable instructions at the same and/or different times.

In some examples, some or all of the circuitry of FIG. 1 may be instantiated, for example, in one or more threads executing concurrently and/or in series. For example, the microprocessor 900 of FIG. 9 may execute machine readable instructions in one or more threads executing concurrently and/or in series. In some examples, the FPGA circuitry 1000 of FIG. 10 may be configured and/or structured to carry out operations/functions concurrently and/or in series. Moreover, in some examples, some or all of the circuitry of FIG. 1 may be implemented within one or more virtual machines and/or containers executing on the microprocessor 900 of FIG. 9.

In some examples, the programmable circuitry 812 of FIG. 8 may be in one or more packages. For example, the microprocessor 900 of FIG. 9 and/or the FPGA circuitry 1000 of FIG. 10 may be in one or more packages. In some examples, an XPU may be implemented by the programmable circuitry 812 of FIG. 8, which may be in one or more packages. For example, the XPU may include a CPU (e.g., the microprocessor 900 of FIG. 9, the CPU 1020 of FIG. 10, etc.) in one package, a DSP (e.g., the DSP 1022 of FIG. 10) in another package, a GPU in yet another package, and an FPGA (e.g., the FPGA circuitry 1000 of FIG. 10) in still yet another package.

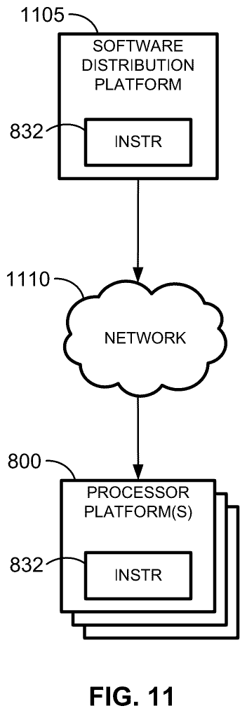

A block diagram illustrating an example software distribution platform 1105 to distribute software such as the example machine readable instructions 832 of FIG. 8 to other hardware devices (e.g., hardware devices owned and/or operated by third parties from the owner and/or operator of the software distribution platform) is illustrated in FIG. 11. The example software distribution platform 1105 may be implemented by any computer server, data facility, cloud service, etc., capable of storing and transmitting software to other computing devices. The third parties may be customers of the entity owning and/or operating the software distribution platform 1105. For example, the entity that owns and/or operates the software distribution platform 1105 may be a developer, a seller, and/or a licensor of software such as the example machine readable instructions 832 of FIG. 8. The third parties may be consumers, users, retailers, OEMs, etc., who purchase and/or license the software for use and/or re-sale and/or sub-licensing. In the illustrated example, the software distribution platform 1105 includes one or more servers and one or more storage devices. The storage devices store the machine readable instructions 832, which may correspond to the example machine readable instructions of FIG. 2, as described above. The one or more servers of the example software distribution platform 1105 are in communication with an example network 1110, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 832 from the software distribution platform 1105. For example, the software, which may correspond to the example machine readable instructions of FIG. 2, may be downloaded to the example programmable circuitry platform 800, which is to execute the machine readable instructions 832 to implement the process control analytics platform 110. In some examples, one or more servers of the software distribution platform 1105 periodically offer, transmit, and/or force updates to the software (e.g., the example machine readable instructions 832 of FIG. 8) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

Notwithstanding the foregoing, in the case of referencing a semiconductor device (e.g., a transistor), a semiconductor die containing a semiconductor device, and/or an integrated circuit (IC) package containing a semiconductor die during fabrication or manufacturing, “above” is not with reference to Earth, but instead is with reference to an underlying substrate on which relevant components are fabricated, assembled, mounted, supported, or otherwise provided. Thus, as used herein and unless otherwise stated or implied from the context, a first component within a semiconductor die (e.g., a transistor or other semiconductor device) is “above” a second component within the semiconductor die when the first component is farther away from a substrate (e.g., a semiconductor wafer) during fabrication/manufacturing than the second component on which the two components are fabricated or otherwise provided. Similarly, unless otherwise stated or implied from the context, a first component within an IC package (e.g., a semiconductor die) is “above” a second component within the IC package during fabrication when the first component is farther away from a printed circuit board (PCB) to which the IC package is to be mounted or attached. It is to be understood that semiconductor devices are often used in orientation different than their orientation during fabrication. Thus, when referring to a semiconductor device (e.g., a transistor), a semiconductor die containing a semiconductor device, and/or an integrated circuit (IC) package containing a semiconductor die during use, the definition of “above” in the preceding paragraph (i.e., the term “above” describes the relationship of two parts relative to Earth) will likely govern based on the usage context.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that enable generation of analytics information. Examples disclosed herein open APIs into data that may be queried to generate a wide range of health indicators. Examples disclosed herein enable long-term monitoring of improving and/or degrading conditions. Examples disclosed herein enable users to build their own analytics. Examples disclosed herein provide obfuscation so that raw data is not sent to an LLM, thereby preserving confidentiality. In examples disclosed herein, instructions are executed locally, thereby optimizing token usage and improving performance. In some examples, instructions can be cached and executed again, thereby enabling generation of analytics visualizations even if the LLM is unavailable. Disclosed systems, apparatus, articles of manufacture, and methods improve the efficiency of using a computing device by enabling analytics information to be quickly developed. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to perform process control analytics are disclosed herein. Further examples and combinations thereof include the following:

Example 1 includes a non-transitory machine readable storage medium comprising instructions to cause programmable circuitry to at least access a request for analytics data from a user of a process control system, generate a prompt based on the request for analytics data, provide the prompt to a large language model for generation of analytics instructions, validate the analytics instructions to determine whether the analytics instructions are to be executed, and in response to the determination that the analytics instructions are to be executed, execute the analytics instructions to generate the analytics data.

Example 2 includes the non-transitory machine readable storage medium of example 1, wherein the instructions cause the programmable circuitry to obfuscate one or more fields in the generated prompt, and deobfuscate one or more fields in the analytics instructions.

Example 3 includes the non-transitory machine readable storage medium of example 2, wherein to obfuscate the one or more fields, the programmable circuitry is to remove confidential information.

Example 4 includes the non-transitory machine readable storage medium of example 1, wherein to validate the analytics instructions, the programmable circuitry is to confirm that the instructions meet a policy of the process control system.

Example 5 includes the non-transitory machine readable storage medium of example 1, wherein to validate the analytics instructions, the programmable circuitry is to confirm that the execution of the instructions will not result in a data breach.

Example 6 includes the non-transitory machine readable storage medium of example 1, wherein the analytics instructions cause the programmable circuitry to access a data source local to the process control system.

Example 7 includes the non-transitory machine readable storage medium of example 1, wherein the instructions cause the programmable circuitry to store the analytics instructions for later execution.

Example 8 includes an apparatus comprising processor circuitry, and a storage device accessible by the processor circuitry, the storage device including machine readable instructions to cause the processor circuitry to access a request for analytics data from a user of a process control system, generate a prompt based on the request for analytics data, provide the prompt to a large language model for generation of analytics instructions, validate the analytics instructions to determine whether the analytics instructions are to be executed, and in response to the determination that the analytics instructions are to be executed, execute the analytics instructions to generate the analytics data.

Example 9 includes the apparatus of example 8, wherein the processor circuitry is to obfuscate one or more fields in the generated prompt, and deobfuscate one or more fields in the analytics instructions.

Example 10 includes the apparatus of example 9, wherein to obfuscate the one or more fields, the processor circuitry is to remove confidential information.

Example 11 includes the apparatus of example 8, wherein to validate the analytics instructions, the processor circuitry is to confirm that the instructions meet a policy of the process control system.

Example 12 includes the apparatus of example 8, wherein to validate the analytics instructions, the processor circuitry is to confirm that the execution of the instructions will not result in a data breach.

Example 13 includes the apparatus of example 8, wherein the processor circuitry is to access a data source local to the process control system.

Example 14 includes the apparatus of example 8, wherein the processor circuitry is to store the analytics instructions for later execution.

Example 15 includes a method for process control system analytics, the method comprising accessing a request for analytics data from a user of a process control system, generating a prompt based on the request for analytics data, providing, by executing an instruction with at least one processor, the prompt to a large language model for generation of analytics instructions, validating, by executing an instruction with the at least one processor, the analytics instructions to determine whether the analytics instructions are to be executed, and in response to the determination that the analytics instructions are to be executed, executing the analytics instructions to generate the analytics data.

Example 16 includes the method of example 15, further including obfuscating one or more fields in the generated prompt, and deobfuscating one or more fields in the analytics instructions.

Example 17 includes the method of example 16, wherein the obfuscation of the one or more fields includes removing confidential information.

Example 18 includes the method of example 15, wherein the validating of the analytics instructions includes confirming that the instructions meet a policy of the process control system.

Example 19 includes the method of example 15, wherein the validating of the analytics instructions includes confirming that the execution of the instructions will not result in a data breach.

Example 20 includes the method of example 15, wherein the analytics instructions cause the at least one processor to access a data source local to the process control system.

Example 21 includes the method of example 15, further including storing the analytics instructions for later execution.

Example 22 includes a method for generating process control system analytics, the method comprising generating a prompt based on a user request for analytics information, the user request received at an edge gateway of a process control system, modifying the prompt to prevent at least one of manipulation of data, leakage of process data, or providing of confidential data to a third party, sending the modified prompt to a large language model for creation of analytics instructions to generate the requested analytics information, validating the analytics instructions, and executing the analytics instructions at the edge gateway to generate the requested analytics information.

Example 23 includes the method of example 22, wherein the analytics instructions are generated based on the execution of the large language model.

Example 24 includes the method of example 22, wherein the LLM is executed at the edge gateway.

Example 25 includes the method of example 22, further including abstracting header information from a dataframe included in the prompt.

Example 26 includes the method of example 25, further including deabstracting the header information into the analytics instructions.

Example 27 includes the method of example 22, wherein the modification of the prompt includes obfuscating one or more terms included in the prompt.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A non-transitory machine readable storage medium comprising instructions to cause programmable circuitry to at least:
access a request for analytics data from a user of a process control system;
generate a prompt based on the request for analytics data;
provide the prompt to a large language model for generation of analytics instructions;
validate the analytics instructions to determine whether the analytics instructions are to be executed; and
in response to the determination that the analytics instructions are to be executed, execute the analytics instructions to generate the analytics data.

2. The non-transitory machine readable storage medium of claim 1, wherein the instructions cause the programmable circuitry to:
obfuscate one or more fields in the generated prompt; and
deobfuscate one or more fields in the analytics instructions.

3. The non-transitory machine readable storage medium of claim 2, wherein to obfuscate the one or more fields, the programmable circuitry is to remove confidential information.

4. The non-transitory machine readable storage medium of claim 1, wherein to validate the analytics instructions, the programmable circuitry is to confirm that the instructions meet a policy of the process control system.

5. The non-transitory machine readable storage medium of claim 1, wherein to validate the analytics instructions, the programmable circuitry is to confirm that the execution of the instructions will not result in a data breach.

6. The non-transitory machine readable storage medium of claim 1, wherein the analytics instructions cause the programmable circuitry to access a data source local to the process control system.

7. The non-transitory machine readable storage medium of claim 1, wherein the instructions cause the programmable circuitry to store the analytics instructions for later execution.

8. An apparatus comprising:
processor circuitry; and
a storage device accessible by the processor circuitry, the storage device including machine readable instructions to cause the processor circuitry to:
access a request for analytics data from a user of a process control system;
generate a prompt based on the request for analytics data;
provide the prompt to a large language model for generation of analytics instructions;
validate the analytics instructions to determine whether the analytics instructions are to be executed; and
in response to the determination that the analytics instructions are to be executed, execute the analytics instructions to generate the analytics data.

9. The apparatus of claim 8, wherein the processor circuitry is to:
obfuscate one or more fields in the generated prompt; and
deobfuscate one or more fields in the analytics instructions.

10. The apparatus of claim 9, wherein to obfuscate the one or more fields, the processor circuitry is to remove confidential information.

11. The apparatus of claim 8, wherein to validate the analytics instructions, the processor circuitry is to confirm that the instructions meet a policy of the process control system.

12. The apparatus of claim 8, wherein to validate the analytics instructions, the processor circuitry is to confirm that the execution of the instructions will not result in a data breach.

13. The apparatus of claim 8, wherein the processor circuitry is to access a data source local to the process control system.

14. The apparatus of claim 8, wherein the processor circuitry is to store the analytics instructions for later execution.

15. A method for generating process control system analytics, the method comprising:
generating a prompt based on a user request for analytics information, the user request received at an edge gateway of a process control system;
modifying the prompt to prevent at least one of manipulation of data, leakage of process data, or providing of confidential data to a third party;
sending the modified prompt to a large language model for creation of analytics instructions to generate the requested analytics information;
validating the analytics instructions; and
executing the analytics instructions at the edge gateway to generate the requested analytics information.

16. The method of claim 15, wherein the analytics instructions are generated based on the execution of the large language model.

17. The method of claim 15, wherein the LLM is executed at the edge gateway.

18. The method of claim 15, further including abstracting header information from a dataframe included in the prompt.

19. The method of claim 18, further including deabstracting the header information into the analytics instructions.

20. The method of claim 15, wherein the modification of the prompt includes obfuscating one or more terms included in the prompt.
